(19) United States
(12) Patent Application Publication
(10) Pub. No.: US 2020/0362751 A1
(43) Pub. Date: Nov. 19, 2020

(54) MULTI-STAGE TURBOCHARGER UNIT, INTERNAL COMBUSTION ENGINE AND METHOD FOR OPERATING A MULTI-STAGE TURBOCHARGER UNIT

(71) Applicant: Perkins Engines Company Limited, Peterborough (GB)

(72) Inventors: David WILKINSON, Peterborough (GB); Edward Haigh, Peterborough (GB); Prabhu Ramasamy, Peterborough (GB)

(73) Assignee: Perkins Engines Company Limited, Peterborough (GB)

(21) Appl. No.: 16/863,927

(22) Filed: Apr. 30, 2020

(30) Foreign Application Priority Data
May 17, 2019 (GB) 1906973.1

(51) Int. Cl. F02B 37/16; F02B 37/18

(52) U.S. Cl. CPC F02B 37/162; F02B 37/013; F05D 2220/40; F02B 37/183

(57) ABSTRACT

The present invention refers to a multi-stage turbocharger unit for an internal combustion engine, comprising an intake passage for supplying charged intake air to the engine having a first and a second compressor which are fluid-communicatively connected via an interstage duct, and a bypass valve configured to supply intake air into the interstage duct by bypassing the first compressor when an interstage pressure prevailing in the interstage duct falls below a threshold value.

### TECHNICAL FIELD

The present invention refers to a multi-stage turbocharger unit, an internal combustion engine equipped with such a multi-stage turbocharger unit and a method for operating a multi-stage turbocharger unit.

### TECHNOLOGICAL BACKGROUND

For improving performance and efficiency of internal combustion engines, the use of turbocharger units is known which use engine's exhaust energy to compress air intake charge. In this way, more air and proportionally more fuel can be forced into a combustion chamber of the engine to provide greater charge density during combustion, thereby increasing power output and engine-operating efficiency.

Turbocharger units are usually equipped with a compressor for charging intake air which is driven by a turbine through which the engine's exhaust gas is guided. For doing so, the compressor and the turbine are typically fixed to a common shaft which rotates in bearings and is accommodated in a bearing housing of the turbocharger unit, wherein the shaft is lubricated by a supply of oil.

Further, internal combustion engines are known which are equipped with a multi-stage turbocharger unit, in which the charging of intake air is performed in at least two subsequent stages, e.g. having a low-pressure turbocharger and a high-pressure turbocharger arranged in series. However, in such a multi-stage turbocharger unit, when the engine is operated in a transient operating mode, a negative pressure may be created in an interstage duct connecting two subsequent compressors of the different turbochargers.

As to substance, during a transient operating mode of the engine, the engine load may be substantially increased which may cause a rapid increase in pressure and mass flow of exhaust gas flowing through the exhaust passage of the engine. Upon propagating through the exhaust passage, the increased exhaust gas flow, at first, is guided through the turbine of the high-pressure turbocharger before passing through the turbine of the low-pressure turbocharger. In this way, the compaction power of the high pressure compressor may sharply rise compared to the low pressure compressor, thereby creating a negative pressure in the interstage duct, i.e. a pressure that is lower compared to a pressure prevailing in an air intake passage upstream from the low-pressure turbocharger.

By being subjected to a negative pressure, oil may leak from the shaft bearings into the intake gas flowing through the compressor housing of the low-pressure turbocharger. This effect is also referred to as oil carry-over which may impair the operation of both the turbocharger unit, i.e. by coating compressor blades with oil, and the engine, i.e. by carrying oil into the combustion chamber.

From US 2018/0202370 A1 a turbocharger unit and a method are known for reducing or eliminating oil carry-over by providing a flow control means for controlling flow of exhaust gas through a turbine of a turbocharger.

### SUMMARY OF THE INVENTION

Starting from the prior art, it is an objective to provide an alternative configuration of a multi-stage turbocharger unit which is suitable for reducing or eliminating oil carry-over effects. In addition, it is an objective to provide an internal combustion engine which is equipped with such a multi-stage turbocharger unit and a method for operating such a multi-stage turbocharger unit.

This is solved by means of a multi-stage turbocharger unit, an internal combustion engine and a method according to the independent claims.

Accordingly, a multi-stage turbocharger unit for use in an internal combustion engine is provided. The turbocharger unit comprises an intake passage for supplying charged intake air to the engine. The intake passage has a first and a second compressor which are fluid-communicatively connected via an interstage duct. The turbocharger unit further comprises a bypass valve configured to supply intake air into the interstage duct by bypassing the first compressor when an interstage pressure prevailing in the interstage duct falls below a threshold value.

Furthermore, an internal combustion engine is provided which is equipped with such a multi-stage turbocharger unit.

Since the internal combustion engine is equipped with the above described multi-stage turbocharger unit, technical features which are described in connection with the multi-stage turbocharger unit in the present disclosure may also relate and be applied to the proposed internal combustion engine, and vice versa.

To that end, a method is provided for operating a multi-stage turbocharger unit installed in an internal combustion engine having an intake passage being provided with a first and a second compressor for supplying charged intake air to the engine, wherein the first and the second compressor are fluid-communicatively connected via an interstage duct. The method comprises the step of supplying intake air into the interstage duct by bypassing the first compressor when an interstage pressure prevailing in the interstage duct falls below a threshold value.

The proposed method may particularly be provided for operating a multi-stage turbocharger unit as described above. Accordingly, technical features which are described in connection with the above multi-stage turbocharger unit or the above internal combustion engine in the present disclosure may also relate and be applied to the proposed method, and vice versa.

### BRIEF DESCRIPTION OF THE DRAWINGS

The present disclosure will be more readily appreciated by reference to the following detailed description when being considered in connection with the accompanying drawings in which:

FIG. 1 schematically shows a reciprocating engine which is equipped with a multi-stage turbocharger unit; and

FIG. 2 schematically shows a reciprocating engine which is equipped with a multi-stage turbocharger unit according to another embodiment.

### DETAILED DESCRIPTION OF PREFERRED EMBODIMENTS

In the following, the invention will be explained in more detail with reference to the accompanying Figures. In the Figures, like elements are denoted by identical reference numerals and repeated description thereof may be omitted in order to avoid redundancies.

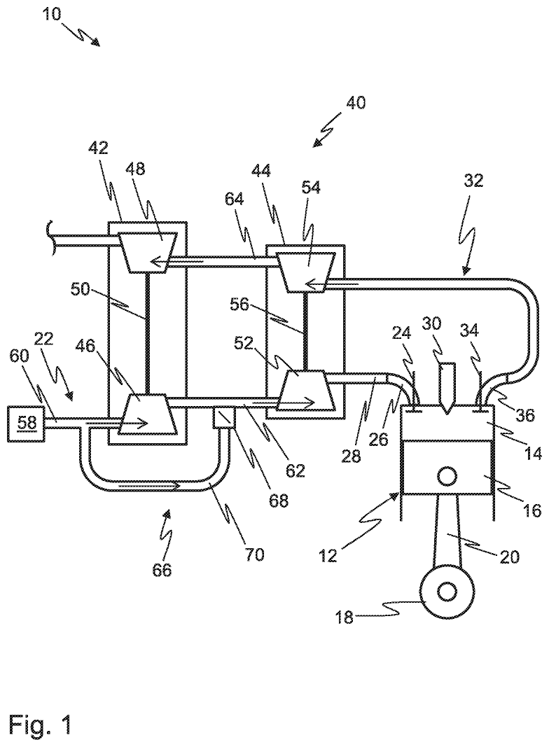

FIG. 1 schematically shows an internal combustion engine 10, also referred to as the ‘engine’ in the following, provided in the form of an reciprocating engine, such as a diesel engine, which is installed on a vehicle (not shown). The engine 10 comprises at least one cylinder 12, preferably more than one cylinder 12, i.e. four, six, eight or more cylinders 12. Each cylinder is provided with a combustion chamber 14 delimited by the cylinder 12 and a piston 16 accommodated therein. The piston 16 is configured for reciprocatingly moving within the cylinder 12 and is connected to a crankshaft 18 of the engine 10 via a connecting rod 20.

During operation of the engine 10, each one of the combustion chambers 14 is supplied with a fuel mixture which is to be ignited therein so as to produce high-temperature and high-pressure gases which apply forces to and thus axially move the associated pistons 16, thereby rotating the crankshaft 18. In this way, chemical energy is transformed into mechanical energy. The fuel mixture to be supplied to and ignited in the combustion chamber 14 is formed by mixing a fuel medium, i.e. diesel fuel, with intake air, i.e. fresh or ambient air from outside the vehicle, within the combustion chamber 14.

Specifically, for supplying intake air into the combustion chamber 14, the engine 10 comprises an intake passage 22 connected to the combustion chamber 14, wherein the supply of intake air into the combustion chamber 14 is variedly adjusted by means of an intake air valve 24. The intake passage 22 is configured for collecting and guiding fresh intake air from outside the vehicle to each one of the combustion chambers 14. In the shown configuration, intake air is guided into the different combustion chambers 14 by means of an intake manifold 26 configured to split an intake air stream flowing through a common flow passage 28 of the intake passage 22 into separate intake air streams, each of which is guided to an associated one of the combustion chambers 14 via separate flow passages of the intake manifold 26.

To that end, for supplying the fuel medium into the combustion chamber 14 of each cylinder 12, a fuel injection valve or pump 30 is provided for variedly injecting the fuel medium into the combustion chamber 14.

The combustion chamber 14 of each cylinder 12 is further connected to an exhaust passage 32 for expelling combustion gases from the combustion chamber 14, i.e. after combustion of the fuel mixture took place. For controlling the expelling of combustion gases, an exhaust gas valve 34 is provided which variedly expels exhaust gases from the combustion chamber 14 into the exhaust passage 32. Exhaust gases are separately expelled from the combustion chambers 14 and are merged to a common exhaust gas stream flowing through the exhaust passage 32 by means of an outtake manifold 36 arranged downstream of the combustion chamber 14. In the context of the present disclosure, the terms “downstream” and “upstream” refer to a flow direction of gases within the engine 10, e.g. a flow direction of intake air flowing through the intake passage 22 and a flow direction of exhaust gases flowing through the exhaust passage 32.

The basic structure and function of such an internal combustion engine 10 and its components are well known to a person skilled in the art and are thus not further specified. Rather, characteristics of a multi-stage turbocharger unit 40 of the engine 10 interlinked with the present invention are addressed in the following. The skilled person will understand that, although not further specified in the present disclosure, the internal combustion engine 10 may be equipped with further components, such as an exhaust gas recirculation system, a particulate filter, etc.

The engine 10 is equipped with the multi-stage turbocharger unit 40 which, at least partly, comprises the intake passage 22 and the exhaust passage 32 described above. Specifically, the shown multi-stage turbocharger unit 40, also referred to as the ‘turbocharger unit’ in the following, is provided in the form of a two-stage turbocharger unit 40 having a first turbocharger 42 constituting a first stage and a second turbocharger 44 constituting a second stage of the turbocharger unit 40. Alternatively, the turbocharger unit 40 may comprise more than two turbochargers and thus more than two stages.

Each one of the first and the second turbocharger 42, 44 is configured to use engine's exhaust energy of exhaust gas flowing through the exhaust passage 32 so as to compress and thus to charge intake air flowing through the intake passage 22. For doing so, the first and second turbochargers 42, 44 are arranged between the intake passage 22 and the exhaust passage 32 in series, as can be gathered from FIG. 1.

Specifically, the first turbocharger unit 42 comprises a first compressor 46 arranged within the intake passage 22 such that an intake air flow flowing through the intake passage 22 is guided therethrough. The first compressor 46 is mechanically coupled to a first turbine 48 in a torque-transmitting manner via a first shaft 50. The first turbine 48 is arranged within the exhaust passage 32 such that exhaust gas flowing through the exhaust passage 32 is guided through the first turbine 48. By such a configuration, the first compressor 46 is driven by the first turbine 48 which is actuated by the engine's exhaust gas guided therethrough. Preferably, the first turbocharger 42 is operated at a relatively low pressure and thus may also be referred to as a low-pressure turbocharger.

The second turbocharger unit 44 comprises a second compressor 52 arranged within the intake passage 22 downstream of the first compressor 46 such that the intake air flow is guided therethrough. The second compressor 52 is mechanically coupled to a second turbine 54 in a torque-transmitting manner via a second shaft 56. The second turbine 54 is arranged within the exhaust passage 32 upstream of the first turbine 48 such that exhaust gas flowing through the exhaust passage 32 is guided through the second turbine 54. The second compressor 52 is driven by the second turbine 54 which is actuated by the engine's exhaust gas guided therethrough. Preferably, the second turbocharger 44 is operated at a relatively high pressure and thus may also be referred to as a high-pressure turbocharger.

By such a configuration, the turbocharger unit 40 may be operated such that intake air drawn into the intake passage 22 is subsequently guided through a first air filter 58, an intake line 60, the first compressor 46, an interstage duct 62 and the second compressor 52 prior to being directed into the intake manifold 26.

The intake line 60 is configured to fluid-communicatively connect the first air filter 58 to an inlet port of the first compressor 46. The interstage duct 62 is configured to fluid-communicatively connect the first compressor 46 and the second compressor 52. For doing so, a first end of the interstage duct 62 is directly connected to an outlet port of the first compressor 46 and a second end of the interstage duct 62, i.e. being arranged opposed to the first end, is directly connected to an inlet port of the second compressor 52.

Accordingly, the turbocharger unit 40 may be operated such that, during operation of the engine 10, exhaust gases flowing through the exhaust passage 32 are subsequently guided through the second turbine 54, a further interstage duct 64 and the first turbine 48. The further interstage duct 64 comprises a first end being directly connected to an inlet port of the second turbine 54 and a second end being directly connected to an inlet port of the first turbine 48 so as to fluid-communicatively connect the second turbine 54 to the first turbine 48.

The turbocharger unit 40 further comprises a bypass passage 66 which is configured to selectively supply intake air into the interstage duct 62 by bypassing the first compressor 46. In the context of the present disclosure, the term “bypassing the first compressor” means that intake air is supplied into the interstage duct 62 which has not been guided through the first compressor 46. For doing so, the bypass passage 66 comprises a bypass valve 68 having an inlet port which is fluid-communicatively connected to the intake line 60 by means of a bypass line 70 and an outlet port which is fluid-communicatively connected to the interstage duct 62. In this way, the turbocharger unit 40 may be operated such that intake air flowing through the intake line 60 is supplied into the interstage duct 62 by bypassing the first compressor 46, i.e. upon being guided through the bypass line 66.

The bypass passage 66, i.e. the bypass valve 68, is configured to supply fresh air or ambient air from the outside of the vehicle into the interstage duct 62 which is non-charged, i.e. has not been guided through the first compressor 46. Accordingly, a bypass pressure prevailing in the bypass line 70 and prevailing at the inlet port of the bypass valve 68 substantially equals to an intake pressure prevailing in the intake line 60 and to an ambient pressure prevailing in the ambient environment outside of the vehicle.

The bypass valve 68 is configured to supply intake air into the interstage duct 62 when an interstage pressure prevailing in the interstage duct 62 falls below a threshold value. More specifically, the bypass valve 68 is configured to open a flow path for supplying intake air into the interstage duct 62 when the interstage pressure falls below the threshold value and to close the flow path when the interstage pressure reaches or exceeds the threshold value. Specifically, the bypass valve 68 may be configured to supply intake air to the interstage duct 62 when the engine 10 is operated in a transient operation, during which engine speed and/or engine load is substantially increased.

In the shown configuration, the threshold value equals to the bypass pressure or the intake pressure. Accordingly, the bypass valve 68 is configured to open the flow path for supplying intake air into the interstage duct 62 when the interstage pressure falls below the bypass pressure and to close the flow path when the interstage pressure reaches or exceeds the bypass pressure.

The bypass valve 68 is a passive valve provided in the form of a one-way valve or a check valve configured to allow intake air to flow through it only in direction from the bypass line 70 to the interstage duct 62. In other words, the bypass valve 68 is configured to allow a flow of intake air from its inlet port in direction to the interstage duct 62 and to block a flow of intake air from the interstage duct 62 in direction to the inlet port of the bypass valve 68. More specifically the bypass valve is provided in the form of a reed valve. Alternatively, the bypass valve may be provided in the form of an active valve, the operation of which may be controlled by a control unit which controls an actuator for switching the bypass valve between its different operational conditions.

In the shown configuration, as set forth above, the bypass passage 66 is configured to direct intake air flowing through the intake passage upstream of the first compressor 46, i.e. flowing through the intake line 60, to the interstage duct 62. For doing so, the bypass line 70 has a first end which opens into the intake line 60 and a second end which is directly connected to the inlet port of the bypass valve 68 in a fluid-communicatively manner. The bypass passage 66, in particular at least one of the bypass valve 68 and the bypass line 70, may be comprised in the first turbocharger 42, in particular in a housing of the first turbocharger 42.

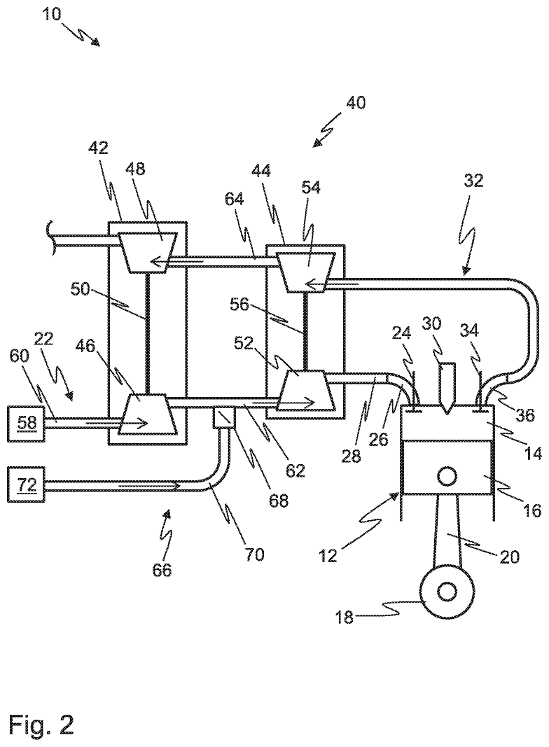

FIG. 2 schematically shows a turbocharger unit 40 according to another embodiment. The turbocharger unit 40 shown in FIG. 2 differs from the configuration depicted in FIG. 1 in that the bypass line 70 is not connected to the intake line 60, i.e. does not open into the intake line 60. By such a configuration, a bypass flow guided through the bypass line 70 is provided separately from an intake flow guided through the intake line 60. In this way, intake air to be guided through the bypass line 70 does not pass the intake line 60, and vice versa. Accordingly, the bypass line 70 may comprise a first end directly connected to a second air filter 72 and a second end directly connected to the inlet port of the bypass valve 68.

According to a further development, the turbochargers unit 40 depicted in FIG. 2 may be provided with a bypass valve 68, i.e. an active bypass valve, which is configured to be activated, i.e. for a predetermined period of time, to supply charge air from the interstage duct 62 to the second air filter 72 when the interstage pressure exceeds a further threshold value, i.e. being greater than the threshold value.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

This is in particular the case with respect to the following optional features which may be combined with some or all embodiments, items and/or features mentioned before in any technically feasible combination.

A multi-stage turbocharger unit for an internal combustion engine may be provided. The multi-stage turbocharger unit may comprise an intake passage for supplying charged intake air to the engine, wherein the intake passage comprises a first and a second compressor which are fluid-communicatively connected via an interstage duct. The multi-stage turbocharger unit may further comprise a bypass valve configured to supply intake air into the interstage duct by bypassing the first compressor when an interstage pressure prevailing in the interstage duct falls below a threshold value.

By being provided with the bypass valve, which is configured to supply intake air into the interstage duct by bypassing the first compressor, the proposed multi-stage turbocharger unit may be provided with a means for preventing the interstage duct from being subjected to a negative pressure. As a result, since the bypass valve is suitable to counteract the built up of a negative pressure in the interstage duct, the proposed configuration effectively reduces or eliminates oil carry-over effects in the multi-stage turbocharger unit. Further, by virtue of the bypass valve, a response of the turbocharger unit may be improved, in particular during a transient operation of the engine.

The proposed multi-stage turbocharger unit may be employed in any suitable turbocharged internal combustion engine, such as a reciprocating engine, in particular a diesel engine. For example, such internal combustion engines may be utilized or be installed in vehicles, i.e. as main or auxiliary engines.

The multi-stage turbocharger unit, also referred to as the ‘turbocharger unit’ in the following, may comprise at least two different stages for charging intake air guided through the intake passage into the engine, i.e. a combustion chamber thereof. Specifically, each stage of the turbocharger unit may be constituted by a separate turbocharger. The turbocharger unit may be provided such that, upon flowing through the intake passage, intake air to be supplied to the engine is subsequently directed through the different stages, i.e. the different turbochargers, of the turbocharger unit. Accordingly, the turbochargers, each of which is associated to a different stage of the turbocharger unit, may be arranged in series in the flow path of the intake air. For example, the turbocharger unit may be a two-stage turbocharger unit comprising two stages, i.e. two turbochargers.

Each of the at least two turbochargers may be arranged between the intake passage and an outtake passage. In this way, the engine's exhaust energy may be used to compress and thus to charge intake air. For doing so, each turbocharger may be equipped with a compressor arranged in the intake passage for charging intake air which is driven by a turbine arranged in the exhaust passage which is actuated by the engine's exhaust gases guided therethrough. The compressor may be mechanically coupled to the turbine via a shaft in a torque-transmitting manner.

Specifically, the turbocharger unit may comprise a first turbocharger and a second turbocharger. The first turbocharger may comprise the first compressor and a first turbine which are mechanically coupled via a first shaft. Accordingly, the second turbocharger may comprise the second compressor and a second turbine which are mechanically coupled via a second shaft. The first turbocharger may be operated at a relatively low pressure and may be referred to as a low-pressure turbocharger or a “low-pressure stage”. The second turbocharger may be operated at a relatively high pressure and thus may be referred to as a high-pressure turbocharger or a “high-pressure stage”.

As set forth above, the intake passage may be configured for supplying charged intake air to the engine, in particular to at least one combustion chamber of the engine. Specifically, the intake passage may be configured to guide fresh air or ambient air drawn into the intake passage from an ambient environment of the engine through the subsequent stages of the turbocharger unit before being supplied into the at least on combustion chamber of the engine via respective intake valves. The first compressor and the second compressor may be arranged in the intake passage such that, upon flowing through the intake passage, intake air is subsequently guided through the first compressor, the interstage duct and the second compressor.

The exhaust passage of the turbocharger unit may be configured for discharging exhaust gas from the at least one combustion chamber during operation of the engine. The first and the second turbine may be arranged in the exhaust passage such that, upon flowing through the exhaust passage, exhaust gases are subsequently guided through the second and the first turbine.

As set forth above, the first compressor and a second compressor are fluid-communicatively connected via the interstage duct. Specifically, a first end of the interstage duct may be coupled, i.e. directly coupled, to an outlet port of the first compressor and a second end of the interstage duct may be coupled, i.e. directly coupled, to an inlet port of the second compressor.

The proposed turbocharger unit further comprises the bypass valve which is configured to supply intake air into the interstage duct by bypassing the first compressor. Again, the term “bypassing the first compressor” in the context of the present disclosure means that intake air is supplied into the interstage duct which has not been guided through the first compressor. In other words, the bypass valve is configured to direct a bypass flow of intake air into the interstage duct, wherein the bypass flow does not pass through the first compressor.

The bypass valve may be configured to supply ambient air into the interstage duct. In other words, the bypass valve may be configured to direct air present in the ambient environment of the engine into the interstage duct. Additionally or alternatively, the bypass valve may be configured to supply non-charged intake air into the interstage duct. The term “non-charged intake air” refers to intake air which is not charged, i.e. which has not been guided through a compressor of a turbocharger. Accordingly, a bypass pressure prevailing in a bypass line upstream of the bypass valve or prevailing at an inlet port of the bypass valve may be equal or substantially equal to an ambient pressure prevailing in the ambient environment of the engine.

Further, the bypass valve may be configured to control the supply of intake air into the interstage duct, i.e. via the bypass line. Accordingly, the bypass valve may be configured to selectively open or close a flow path for supplying intake air into the interstage duct. The bypass valve may be switched between an open position, in which the flow path through the bypass valve is opened, and a closed position, in which the flow path through the bypass valve is blocked.

Specifically, the bypass valve may be configured to open the flow path for supplying intake air into the interstage duct when the interstage pressure falls below the threshold value. Accordingly, the bypass valve may be configured to close the flow path when the interstage pressure reaches or exceeds the threshold value.

In this way, the bypass valve may be controlled on the basis of a comparison of the interstage pressure with the threshold value. Specifically, the threshold value may be equal to an intake pressure prevailing upstream of the bypass valve, i.e. in the bypass line, or prevailing at the inlet port of the bypass valve. In other words, when a pressure difference across the bypass valve is negative, the bypass valve may be configured to open so as to supply intake air into the interstage duct. In other words, the bypass valve may be configured to open when a pressure prevailing at its inlet port, i.e. corresponding to the bypass pressure, is greater than a pressure prevailing at its outlet port, i.e. corresponding to the interstage pressure.

Preferably, the bypass valve is a passive valve. This means that the operational state of the bypass valve is controlled by the conditions of the fluid present at its ports, i.e. at its inlet port and outlet port.

Alternatively, the bypass valve may be an active valve having an actuator for switching its operational state. For example, the bypass valve may be provided with a control unit configured to actuate or control the actuator for switching the operational position of the bypass valve. In such a configuration, the control unit may be configured to determine the threshold value and the interstage pressure and based thereupon to control the actuator and thus the operation state of the bypass valve.

Further, the bypass valve may be provided in the form of a one-way valve or a check valve. In such a configuration, the bypass valve allows fluid, i.e. intake air, to flow through it in only one direction. Specifically, the bypass valve may be configured to allow a flow of intake air from an inlet of the bypass valve to the interstage duct and to block a flow of intake air from the interstage duct to the inlet via the bypass valve. In other words, the bypass valve may be configured to allow supply of intake air into the interstage duct via the bypass valve and to block discharge of intake air from the interstage duct via the bypass valve. Further, the bypass valve may be a spring loaded valve, i.e. loaded towards its closed position. Alternatively or additionally, the bypass valve may be a reed valve.

In a further development, the bypass valve may be configured to direct intake air flowing through the intake passage, i.e. upstream of the first compressor, to the interstage duct. In other words, intake air flowing through an intake line arranged upstream of the first compressor may be guided through the bypass valve into the interstage duct. In this way, intake air drawn into the intake passage may be guided into the interstage duct via the bypass valve, thereby bypassing the first compressor. Accordingly, in a state, in which the bypass valve is open, intake air drawn into the intake passage may be subsequently guided through the intake line arranged upstream of the first compressor, the bypass line, the bypass valve, the interstage duct and the second compressor before being supplied into the at least one combustion chamber of the engine. For fluid-communicatively connecting the bypass valve to the intake line, the bypass line may have a first end which opens into the intake line of the intake passage arranged upstream of the first compressor and a second end which is fluid-communicatively connected, i.e. directly connected, to the inlet port of the bypass valve.

Alternatively or additionally, the intake passage may comprise an intake line fluid-communicatively connected to and arranged upstream of the first compressor and the turbocharger unit may be equipped with a bypass line fluid-communicatively connected to and arranged upstream of the bypass valve such that a bypass flow guided through the bypass line is provided separately from an intake flow guided through the intake line. In other words, intake air to be guided through the bypass line does not pass the intake line, and vice versa. Further, the intake line may comprise a first end connected to a first air filter and a second end connected to an inlet port of the first compressor. The bypass line may comprise a first end connected to a second air filter and a second end connected to the inlet port of the bypass valve.

In such a configuration, the bypass valve may be configured to be actuated for a predetermined period of time so as to supply charged air from the interstage duct to the second air filter when the interstage pressure exceeds the threshold value, in particular a further pressure value being greater than the first threshold value. In this way, charged air from the interstage duct may be discharged in the ambient environment of the engine via the second air filter. By doing so, dust accommodated in the second filter may be blown out therefrom, thereby cleaning the second filter.

In a further development, at least one of the bypass valve and the bypass line may be comprised in the first turbocharger, in particular may be arranged within a housing of the first turbocharger.

Furthermore, an internal combustion engine may be provided which is equipped with a multi-stage turbocharger unit as described above.

To that end, a method may be provided for operating a multi-stage turbocharger unit installed in an internal combustion engine having an intake passage for supplying charged intake air to the engine. The intake passage may be provided with a first and a second compressor which are fluid-communicatively connected via an interstage duct. The method may comprise a step of supplying intake air into the interstage duct by bypassing the first compressor when an interstage pressure prevailing in the interstage duct falls below a threshold value. Specifically, the step of supplying intake air to the interstage duct may be performed during a transient operation of the engine.

1. A multi-stage turbocharger unit for an internal combustion engine, comprising an intake passage for supplying charged intake air to the engine having a first and a second compressor which are fluid-communicatively connected via an interstage duct, and a bypass valve configured to supply intake air into the interstage duct by bypassing the first compressor when an interstage pressure prevailing in the interstage duct falls below a threshold value.

2. The multi-stage turbocharger unit according to claim 1, wherein the bypass valve is configured to supply ambient air or non-charged intake air into the interstage duct.

3. The multi-stage turbocharger unit according to claim 1, wherein the bypass valve is configured to open a flow path for supplying intake air into the interstage duct when the interstage pressure falls below the threshold value and to close the flow path when the interstage pressure reaches or exceeds the threshold value.

4. The multi-stage turbocharger unit according to claim 1, wherein the threshold value equals to a bypass pressure prevailing at an inlet port of the bypass valve.

5. The multi-stage turbocharger unit according to claim 1, wherein the bypass valve is a passive valve.

6. The multi-stage turbocharger unit according to claim 1, wherein the bypass valve is a one-way valve or a check valve which is configured to allow a flow of air from an inlet port of the bypass valve to the interstage duct and to block a flow of intake air from the interstage duct to the inlet port via the bypass valve.

7. The multi-stage turbocharger unit according to claim 1, wherein the bypass valve is a reed valve.

8. The multi-stage turbocharger unit according to claim 1, wherein the bypass valve is configured to direct intake air flowing through the intake passage upstream of the first compressor to the interstage duct.

9. The multi-stage turbocharger unit according to claim 8, further comprising a bypass line having a first end which opens into an intake line of the intake passage arranged upstream of the first compressor and a second end which is fluid-communicatively connected to an inlet port of the bypass valve.

10. The multi-stage turbocharger unit according to claim 1, wherein the intake passage comprises an intake line fluid-communicatively connected to and arranged upstream of the first compressor, and wherein the turbocharger unit further comprises a bypass line fluid-communicatively connected to and arranged upstream of the bypass valve, wherein a bypass flow guided through the bypass line is provided separately from an intake flow guided through the intake line.

11. The multi-stage turbocharger unit according to claim 10, wherein the intake line comprises a first end connected to a first air filter and a second end connected to an inlet port of the first compressor, and wherein the bypass line comprises a first end connected to a second air filter and a second end connected to an inlet port of the bypass valve.

12. The multi-stage turbocharger unit according to claim 10, wherein the bypass valve is further configured to be actuated for a predetermined period of time to supply charged air from the interstage duct to the second air filter when the interstage pressure exceeds a further threshold value.

13. The internal combustion engine comprising a multi-stage turbocharger unit according to claim 1.

14. The method for operating a multi-stage turbocharger unit installed in an internal combustion engine having an intake passage being provided with a first and a second compressor for supplying charged intake air to the engine, wherein the first and the second compressor are fluid-communicatively connected via an interstage duct, the method comprises the step of supplying intake air into the interstage duct by bypassing the first compressor when an interstage pressure prevailing in the interstage duct falls below a threshold value.

15. The method according to claim 14, wherein the step of supplying intake air to the interstage duct is performed during a transient operation of the engine.
